(19) United States
(12) Patent Application Publication
(10) Pub. No.: US 2003/0182210 A1
(43) Pub. Date: Sep. 25, 2003

(54) Producing and sharing personalized photo calendar

(76) Inventors: Erik Weitzman, Redwood City, CA (US); Christopher Humphrey, Oakland, CA (US); Xin Wen, Palo Alto, CA (US)

Correspondence Address: Bao Tran, Tran & Associates, 6768 Meadow Vista Court, San Jose, CA, 95135, US

(21) Appl. No.: 10/106,902

(22) Filed: Mar. 25, 2002

(51) Int. Cl. G06F 17/60

(52) U.S. Cl. 705/27

(57) ABSTRACT

A method for producing a personalized photo calendar is provided. Digital images are generated by a user. A calendar layout is displayed. The calendar layout includes at least one image field for receiving a digital image. The user selects one of the digital images. The calendar layout is rendered with the selected image in the image field to form the personalized photo calendar.

The present invention is related to commonly assigned U.S. patent application Ser. No. 09/436,704, filed on Nov. 9, 1999, titled “Distributing Images to Multiple Recipients”, by Baum, U.S. patent application Ser. No. 09/450,075, filed on Oct. 27, 1999, titled “Printing Images in an Optimized Manner”, by Baum, et al., U.S. patent application Ser. No. 09/428,871 filed Oct. 27, 1999, titled “Multi-Tier Data Storage System”, U.S. patent application Ser. No. 09/721,484, filed on Nov. 22, 2000, titled “User Interface and Methods for On-line Print Service”, by Manolis, et al., U.S. patent application Ser. No. 09/450,804, filed on Nov. 29, 1999, titled “Image Uploading”, by Manolis, et al., U.S. patent application Ser. No. 09/560,609, filed on Apr. 28, 2000, titled “System and Method of Providing a User Interface for Changing Attributes of an Image-based Product”, by Haeberli, and U.S. patent application Ser. No. 09/684,595, filed on Oct. 5, 2000, titled “Previewing a framed image print”, by Haeberli. The disclosure of these related applications are incorporated herein by reference.

### TECHNICAL FIELD

This application relates to creating, producing, sharing, and distributing personalized calendars.

### BACKGROUND

Calendars are typically printed with static designs and in large quantities. They can commonly be purchased at bookstores and other retail locations. In everyday use, calendar users often put reminders on calendars by marking their personal events at the corresponding dates on a calendar page. The personal events can include social gatherings, school activities, vacations, and bill payment, etc. For aesthetic reasons, it may be useful to have such personal event information printed on the calendar. For example, U.S. Pat. No. 6,269,341 discloses “a method and system for making an individualized calendar which includes personalized information. The personalized information includes a special event date with its description for an individual for whom the calendar is to be made.”

Calendars generally show dates of January through December, and users usually purchase them at the end of the previous year. Some users may have the additional needs for “a calendar producing system, a producing method, a selling system and a selling method in which a calendar can be produced and purchased all through the year and can be delivered to a user quickly”, as disclosed in U.S. Patent Application 20010010772.

### SUMMARY

The invention relates to methods and apparatus for producing a personalized photo calendar for a user. The method includes a) receiving one or more user generated digital images; b) displaying a calendar layout, such calendar layout including at least one image field for receiving a digital image; c) selecting a user generated digital image from the received user generated digital images; and d) rendering the calendar layout with selected user generated image in the image field to form the personalized photo calendar.

Advantages of the system may include one or more of the following. The system provides an electronic or a hardcopy personalized calendar. The system provides a personalized calendar including a user's personal photos. The resulting online photo system allows a user to create a personalized photo calendar, to purchase a hardcopy of the personalized photo calendar and to ship it to a recipient as specified by the user. The system also supports a graphical user interface for creating a personalized photo calendar on a computer or at a photo hosting website provided by a photo service provider. The data for such personalized calendar can be stored on a central data storage device. The user can order a hardcopy of a personalized photo calendar from the photo hosting website.

Another advantage of the present invention is that the calendars are customized with a user's personal photo and therefore is more personal to the user.

Yet another advantage of the invention is that the personal photos can be included in the calendar in conjunction with a user's personal events.

A further advantage of the present invention is that the personalized photo calendar can be conveniently created, and a hardcopy calendar ordered on at a photo hosting website on the Internet from a user's computer. The user can conveniently select her personal photos from her photo albums stored at the photo hosting website to create a personalized photo calendar. Upon receiving an order for a hardcopy of such a personalized photo calendar, the photo service provider hosting the website can produce a hard copy of the personalized photo calendar and have it shipped to the recipients as specified by the user.

Yet another advantage of the present invention is that the methods and systems it provides can be used by consumers and business customers to produce personalized photo calendars.

The details of one or more embodiments are set forth in the accompanying drawings and in the description below. Other features, objects, and advantages of the invention will become apparent from the description and drawings, and from the claims.

### DRAWING DESCRIPTIONS

FIG. 1 is an exemplary block diagram showing a system for producing personalized photo calendars in accordance with the present invention.

FIG. 2 shows a typical computer that a user uses for receiving digital image data from a digital image capture device and for accessing a photo hosting website on the Internet.

FIG. 3 shows an example of a graphical user interface as viewed on the computer display for creating a personalized photo calendar.

FIG. 4 shows another example of a graphical user interface for creating a personalized photo calendar. The image filed overlaps with the date information in the calendar layout.

FIG. 5a shows a perspective preview of a hardcopy personalized photo calendar. The hardcopy personalized photo calendar comprises a personalized cover page including a user's personal photos.

FIG. 5b shows a calendar page from the calendar book shown in FIG. 5a.

FIG. 5c shows a planar view of two hardcopy personalized photo calendars in different formats.

FIG. 6 shows another layout of a personalized photo album in which the dates and the personal photos are distributed in a plurality of cells.

FIG. 7 is an illustration of an electronic calendar including a user's personal event information associated with different dates. The personal event information can be extracted by an application program for producing a personalized photo calendar for the user.

### DETAILED DESCRIPTION

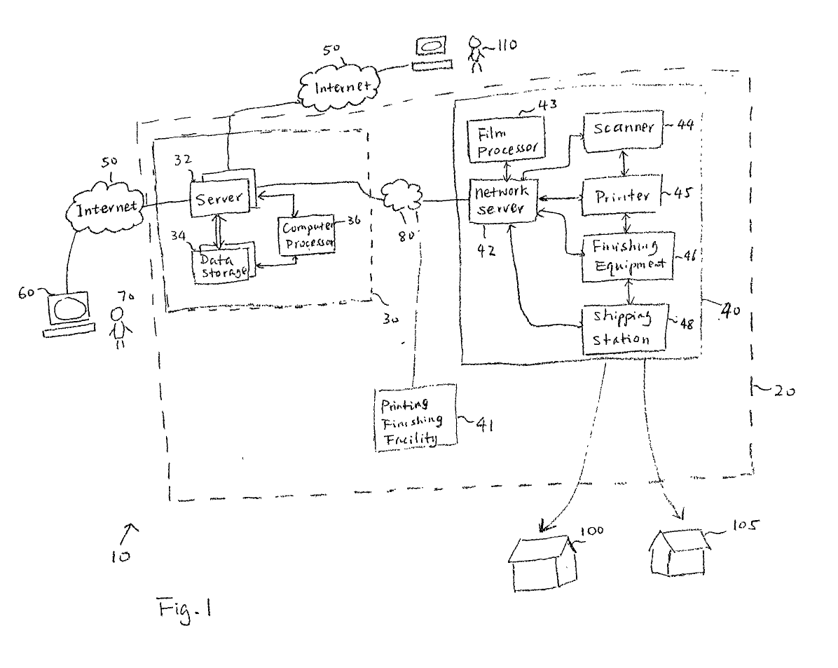

FIG. 1 shows a block diagram of the system 10 for producing personalized photo calendars in accordance with the present invention. An online photo system 20 is established by a photo service provider to provide photo services on a wide area network such as the Internet 50. The online photo system 20 includes a data center 30 and one or more printing and finishing facilities 40 and 41

The data center 30 includes one or more servers 32, data storage devices 34 for storing image data, user account and order information, and one or more computer processors 36 for processing orders and rendering digital images. An online-photo website is powered by the servers 32 to serve as a web interface between the users 70 and the photo service provider. The printing and finishing facilities 40,41 can produce hardcopy photo products such as personalized photo calendars, photographic prints, greeting cards, post cards, trading cards, photo albums, photo books, photo T-shirt, photo mugs, and record images on compact disks (CDs).

The architecture of the data storage devices 34 are designed to optimize the data accessibility, the reliability of the data storage and the cost. Further details on the image data storage in online photo system 20 are provided in the commonly assigned and above referenced U.S. patent application Ser. No. 09/428,871 filed Oct. 27, 1999, titled “Multi-Tier Data Storage System”, which is incorporated herein by reference.

The printing and finishing facilities 40,41 can be co-located with the data center 30. Or alternatively, the printing and finishing facility 40,41 can be remotely located from the data center 30. Multiple printing and finishing facilities 40,41 can be set up so that each printing and finishing facility 40,41 can be located geographically close to the customers to shorten order delivery time. Furthermore, the printing and finishing facilities 40,41 and the data center 30 can be owned and operated by different business entities. For example, the data center 30 can be owned by a first business entity that hosts a website that provides a web front and web user interface for the user 70. The printing and finishing facilities 40,41 can be owned by a second business entity that fulfills the production of physical photo products for the first business entity. In this particular arrangement, the second business entity is often referred as an Application Service Provider (ASP). The photo service provider can provide services to its customers from its own website, as well as fulfill (i.e. ASP) photo products for websites hosted by other business entities.

The printing and finishing facility 40 includes network servers 42 for communicating with the data center 30, printers 45 for printing images on physical surfaces, finishing equipment 46 for operations after the images are printed, and shipping stations 48 for confirming the completion of the orders and shipping the ordered photo products to recipients 100 and 105 (the user 70 can be a recipient). The printing and finishing facilities 40,41 can include a film processor 43 for processing exposed films, and a scanner 44 for digitizing a processed film stripe. The network servers 42 are connected with the data center 30 via a computer network 80 such as a Local Area Network or a Wide Area Network. The order information and image data can be transferred from servers 32 to the network servers 42 using a standard or a proprietary protocol (FTP, HTTP, XML, etc.). The finishing equipment 46 can perform any operations for finishing a complete photo product other than photo printing such as cutting, folding, adding a cover to photo book, punching, stapling, gluing, binding, envelope printing and sealing, packaging, labeling, weighing and postage metering. The finishing operations can also include framing a photo print, recording image data on a CD-ROM, etc. Furthermore, the printers and the finishing equipments can be located in different sites. Some of the finishing operations may be fulfilled by contracting an external finishing provider.

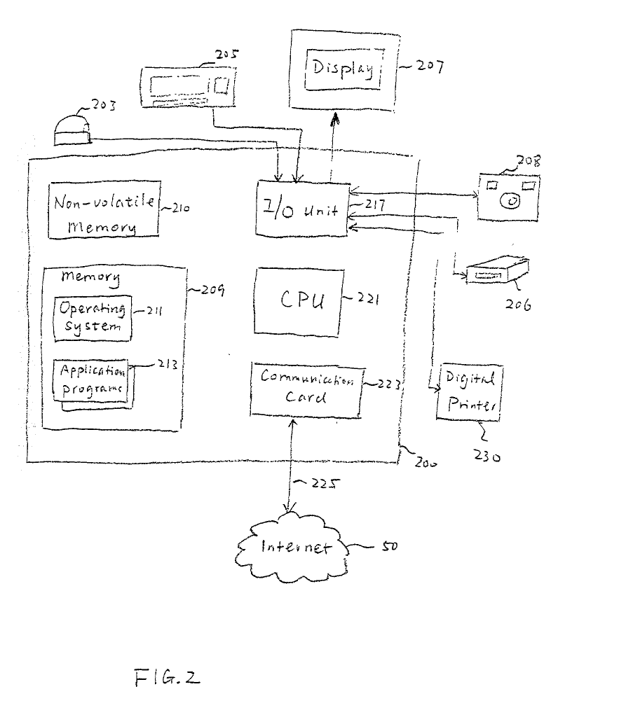

A user 70 can access the online-photo website using a computer terminal 60 as shown in FIG. 2. The computer terminal 60 can be a personal computer located at a home or at a business, or a public entry terminal such as a kiosk. The computer terminal 60 allows a user 70 to execute software to perform tasks such as communicating with other computer users, accessing various computer resources, and viewing, creating, or otherwise manipulating electronic content, that is, any combination of text, images, movies, music or other sounds, animations, 3D virtual worlds, and links to other objects. Exemplary components of the computer terminal 60, shown in FIG. 2, include input/output (I/O) devices (mouse 203, keyboard 205, display 207) and a general purpose computer 200 having a central processor unit (CPU) 221, an I/O unit 217 and a memory 209 that stores data and various programs such as an operating system 211, and one or more application programs 213 including applications for viewing, managing, and editing digital images (e.g., a graphics program such as Adobe Photoshop). The computer 200 also includes non-volatile memory 210 (e.g., flash RAM, a hard disk drive, and/or a floppy disk, CD-ROM, or other removable storage media) and a communications device 223 (e.g., a modem or network adapter) for exchanging data with an Internet 50 via a communications link 225 (e.g., a telephone line).

In accordance with the present invention, the computer 200 allows the user 70 to connect to the online-photo website using the communications card or device 223. The user 70 can set up and access her personal account. The user 70 can enter user account information such as the user's name, address, payment information (credit card number), and information about the recipient of the photo products ordered by the user 70. The user 70 can also enter payment information such as credit card number, the name and address on the credit card etc. The user 70 can also send digital image data to the online-photo web site.

Other user operations can include storing the images in an online photo album, creating personalized photo calendar, and ordering a hardcopy personal photo calendar. In addition, the user 70 can order hardcopy personalized photo calendars and have them shipped to recipients 100 and 105. The user 70 can also share her personalized photo calendar with a share recipient 110 on the Internet 50. Upon receiving the personalized photo calendar from the user 70, the share recipient 110 is authorized to order a hardcopy o personalized photo calendar 500 (as discussed in more detail below) from the online photo website provided by the photo service provider.

The computer 200 of FIG. 2 can also be connected to various peripheral I/O devices such as an image capture device (digital camera, film or reflective scanners). One such peripheral device is a digital camera 208 that enables users to take pictures and save them in digital (electronic) format. Typically, the digital camera 208 is connected to the computer 200 only while the user is transferring images to the computer's disk drive or other non-volatile memory 210. The digital camera 208 can be connected to the computer 200 using a Firewire or an USB port, from a camera cradle (e.g. Kodak DX3900 using an EasyShare Camera Dock), or over wireless media such as radio or light. The digital images captured by a digital camera are typically stored in memory card (e.g., SmartMedia™ or CompactFlash™) that are detachable from the digital camera. The digital images on a memory card can be transferred to the computer 200 using a card reader 206 and saved on non-volatile memory 210.

The user 70 can also obtain digital images from film-based prints from a traditional camera, by sending an exposed film into a photo-finishing service, which develops the film to make prints and/or scans (or otherwise digitizes) the prints or negatives to generate digital image files. The digital image files then can be downloaded by the user or transmitted back to the user by e-mail or on a CD-ROM, diskette, or other removable storage medium. The users can also digitize images from a negative film using a film scanner that is connected to the computer 200 or from a reflective image print using a flatbed scanner. Digital images can also be created or edited using an application program 213 (e.g., a graphics program such as Adobe Photoshop).

Once the digital images are stored on the computer 200, a user can perform various operations on them using application programs 213 stored in memory 209. For example, an image viewer application can be used for viewing the images and a photo editor application can be used for touching up and modifying the images. In addition, an electronic messaging (e.g., e-mail) application can be used to transmit the digital images to other users. In accordance with the present invention, one of the application programs 213 can enable the user 210 creating a personalized photo calendar on the computer 200. Several of the above described imaging functions can be incorporated in one imaging software, which can be provided by the photo service provider and installed on computer 200 for the user 70. More details about application programs 213 for image enhancement and image management.

In addition to viewing the digital images on the computer display 207, the user 70 may desire to have physical photo products made of digital images. Photo prints can be generated by the user 70 using a digital printer 230 that is connected to the computer 200. Typical digital printers 230 can include such as an inkjet printer or a dye sublimation printer. The user 70 can also purchase from an online photo service provider photo products that are not easily produced at home or even at a retail store. In accordance with embodiments of the present invention, examples of such photo products may include personalized photo calendars, photo prints based on silver halide photographic paper (versus ink jet receiver used by ink jet printers), personalized photo greeting cards, photo books and albums, photo T-shirt, and photo, mugs etc. The production of these photo products often require the use of commercial equipment which are usually only available at a commercial production location such as the printing and finishing facilities 40 and 41. One online photo service provider that makes such photo products is Shutterfly, Inc., located at Redwood City, Calif., U.S.A.

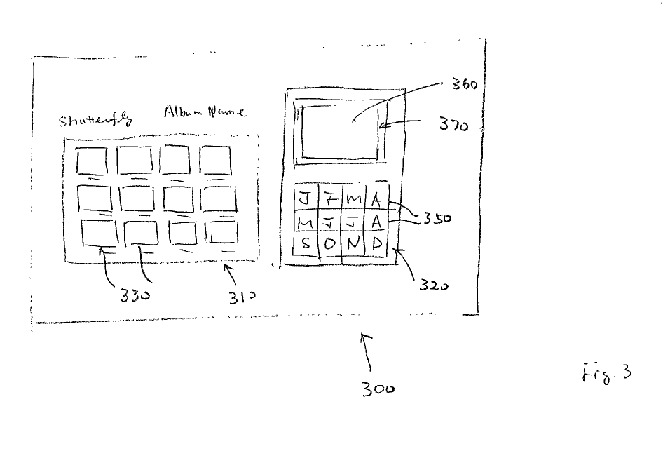

In accordance with the present invention, the user 70 can be a consumer that accesses the computer terminal 60 from home or a public entry terminal. The user 70 can also be a business owner or employee that may access the computer terminal 60 at a retail location such as a photo shop or a printing store. In the latter case, the digital images may be generated by a customer of the business and later provided the business for receiving an imaging service. An advantage of the present invention, as described above, is that it allows the business to provide photo products that are otherwise unavailable at the business location. For example, the hardcopy personalized photo calendars 500 may require the use of commercial printing press and finishing equipment that are typically not available at retail business locations. The formats of communication between the computer terminal 60 and the servers 32 as well as the graphic user interface (as described below relating to FIGS. 3 through 7) can be customized for the consumer and commercial customers.

The computer terminal 60 can also be a public entry terminal such as a kiosk for receiving digital image data from the user 70 and uploading the digital images to the server 32. After the digital image files have been uploaded, the user can view, manipulate and/or order prints in the manners described above. The public entry terminal can also support various electronic payment and authorization mechanisms, for example, a credit or debit card reader in communication with a payment authorization center, to enable users to be charged, and pay for, their prints at the time of ordering.

A typical process of using an online photo service is now described. The user 70 sends digital images to the servers 32 provided by the online photo system 20 by uploading over the Internet 50 using a standard or a proprietary protocol (FTP, HTTP, XML, for example) or electronic communication application (for example, e-mail or special-purpose software provided by the photo-finisher). The user 70 can also send digital image data stored on a physical storage medium such as a memory card or recordable CD by US mail, overnight courier or local delivery service. The photo-finisher can then read the images from the storage medium and return it to the user, potentially in the same package as the user's print order. In addition, the photo service provider can load data or programs for the user's benefit onto the storage medium before returning it to the user. For example, the photofinisher can load the storage medium with an application program 213 for the user to create a personalized photo calendar on his computer 200.

The user can also send a roll of exposed film, and processed film negatives to the photo service provider. The exposed film is processed by the film processor 43 and digitized by the scanner 44 in the printing and finishing facilities 40, 41. The digital image data output from the scanner 44 is stored on the data storage 34.

After the photo service provider has received the user's digital images, the photo service provider can host the images on the online photo website, at which the user can view and access the images using a browser application. The user 70 accesses the online-photo website to designate which of the images should be reproduced on a photo product, parameters relating to printing (e.g., finish, size, number of copies), and one or more recipients 100, 105 to whom the photo products are to be sent.

In addition to hosting the user's images on a web page, the photo service provider usually stores the images in an image archive on in the data storage 34 so that the user 60 and others given authorization by the user (e.g. the share recipient 110) can access them in the future.

After the user's images have reached the photo service provider and have been made available online, the user can place an order with the photo service provider. One way to place an order is by having the user 70 view the images online, for example, with a browser and selectively designate which images should be printed. The user can also specify one or more recipients 100,105 to whom prints should be distributed and, further, print parameters for each of the individual recipients, for example, not only parameters such as the size, number of copies and print finish, but potentially also custom messages to be printed on the back or front of a print.

The information stored in the data storage 34 is provided to a printing and finishing facilities 40,41 for generating photo products. The photo products include photographic prints, but also any other item to which graphical information can be imparted, for example, greeting or holiday cards, books, calendars, playing cards, T-shirts, coffee mugs, mouse pads, key-chains, or any other type of gift or novelty item. The photo products are printed by the printer 45 and finished by finishing equipment 46 according to the printing parameters as specified by the user 70. The photo products are then delivered to the specified recipients 100, 105 using standard U.S. Mail, or courier services such as Federal Express or UPS.

Further details on the generation and distribution of photo products using online photo system 20 are provided in the commonly assigned and above referenced U.S. patent application Ser. No. 09/436,704, filed on Nov. 9, 1999, titled “Distributing Images to Multiple Recipients”, by Baum and U.S. patent application Ser. No. 09/450,075, filed on Oct. 27, 1999, titled “Printing Images in an Optimized Manner”, by Baum, et al. The disclosures of these patent applications are herein incorporated by reference.

FIG. 3 shows a graphical user interface 300 as viewed on the computer terminal 60 by the user 70. The graphical user interface 300 can be a web page provided from a website hosted by the photo service provider and viewable using a web browser program such as Microsoft Internet Explorer or Netscape. The graphical user interface 300 can also be provided by a local application program 213 residing on the computer 200. The graphical user interface 300 includes a photo album 310 and a calendar layout 320. The photo album 310 includes a plurality of digital images 330 that are provided by the user 70. A detailed view of a digital image 330 can be obtained by clicking on the digital image with a mouse, for example. The digital images 330 may be originally captured by a digital camera and subsequently transferred to the computer 200, as previously described. The digital images 330 may also have been digitized from a reflective print or film. The digital images 330 include personal photos from the user 70. In the case that the graphical user interface 300 is a web page from online photo website powered by the server 32, the digital images 330 have been sent to the server 32 either by data transfer over the Internet 50 or by mailing a memory device containing the digital images to the photo service provider. Details of uploading a user's digital image to an online photo hosting website are disclosed in the commonly assigned and above referenced U.S. patent application Ser. No. 09/450,804, filed on Nov. 29, 1999, titled “Image Uploading”, by Manolis, et al., the disclosure of which is are incorporated herein by reference.

Although not shown, the graphical user interface 300 can include tools for image enhancement and management. For example, the user 70 can use such image enhancement tools to crop a digital image 330 for the use in the personalized photo calendar (as described below), to change the colors (e.g. to black and white, or sepia, etc.), to apply special effects such as water color or oil painting on the digital image 330. The image enhancement tools also allow the user 70 to change tone scale, fix red eyes, or add a border to the digital image 330. The graphical user interface 300 also allows the user 70 to add and edit a title, annotation, and keywords to a digital image 330. The image management tools allow the user to organize and display the digital images 330 based on keywords, titles and annotations. Details of the graphical user interface for viewing and managing a user's photo albums, and for managing the user account and recipient information are disclosed in the commonly assigned and above referenced U.S. patent application Ser. No. 09/721,484, filed on Nov. 22, 2000, titled “User Interface and Methods for On-line Print Service”, by Manolis, et al., the disclosure of which is are incorporated herein by reference.

The calendar layout 320 includes a plurality of cells 350, each of which is associated with a date. For example, there can be twelve cells 350 with each representing a month in a year as shown in FIG. 3. The calendar layout can include information ethnic calendars (a lunar calendar, Chinese calendar, among others) including ethnic and/or religious holidays. In accordance with the present invention, the calendar layout 320 further includes one or more image fields 360 for receiving a digital image.

The image field 60 can be surrounded by an image border 370. The image border 370 is pre-designed, which can provide a theme to the image. Examples of a theme can include seasons (spring, summer, among others), school, family, kids, sports, birthday, graduation, wedding, culture and ethnic information (Christmas, Thanksgiving, the year of the horse, Jewish New Year, kwanza, among others), etc. The image border 370 can be changed by selecting from pre-designed image borders. Details of about image borders, image enhancement, and graphical user interface for viewing and managing a user's photo albums are disclosed in the commonly assigned and above referenced U.S. patent application Ser. No. 09/560,609, filed on Apr. 28, 2000, titled “System and Method of Providing a Graphical user interface for Changing Attributes of an Image-based Product”, by Haeberli, the disclosure of which is are incorporated herein by reference.

The graphical user interface 300 provides functions for inputting the start date, the end date, and the time increment for the personalized photo calendar. For example, a calendar can start from Jan. 1, 2002, ends in Dec. 31, 2002, incremented by day, and grouped month by month. A calendar layout can also just cover a quarter or a month. In accordance with the present invention, the personalized photo calendar allows the user to vary the start time, the end time, as well as the time increment. For example, a user 70 may start a new calendar from July, 2000 and end in June, 2003. Another user 70 can design a calendar for only a quarter in the 3^{rd} quarter of year 2002. The user may order a hardcopy personalized photo calendar 500 every quarter so the user 70 can select most update personal photos for her personalized photo calendar.

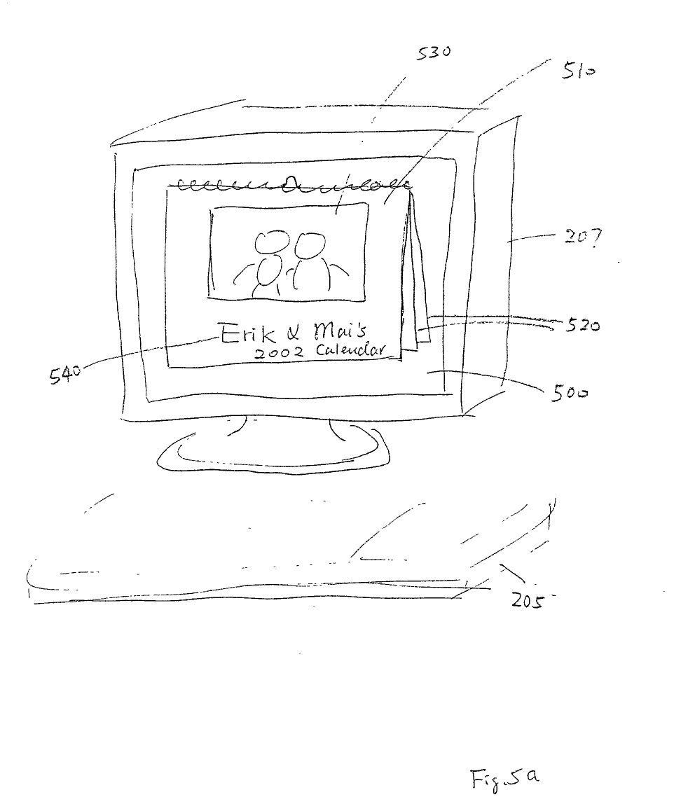

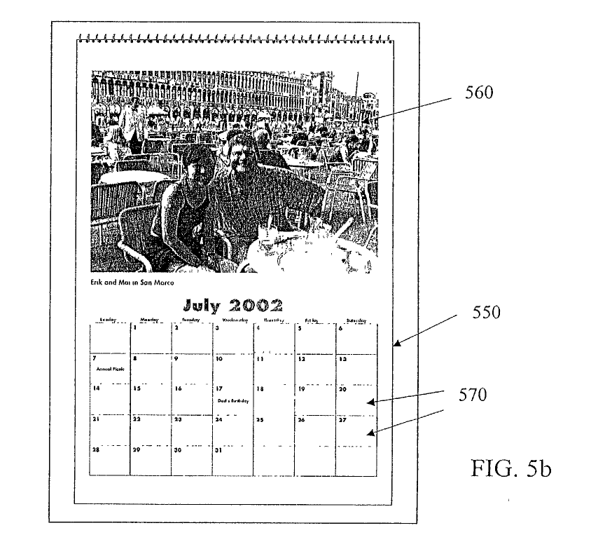

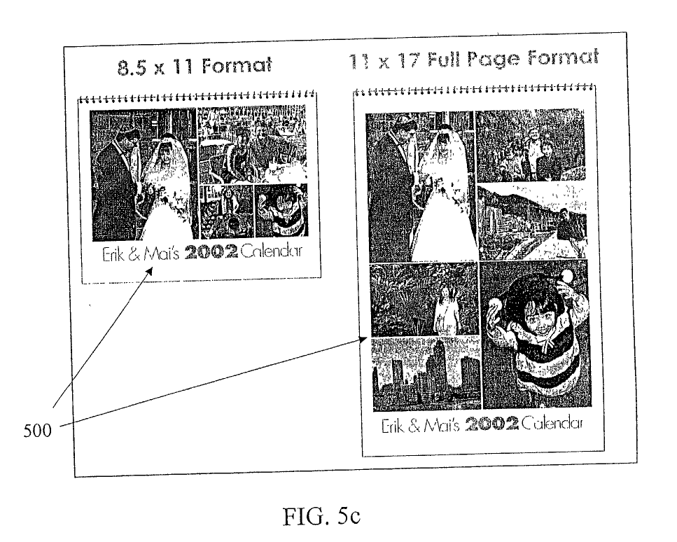

In accordance with the present invention, the user 70 can render the calendar layout 320 using one or more of the digital images 330 to produce a personalized photo calendar. The user 70 can select one of the digital images 330 by positioning the cursor to the digital image and clicking with a mouse. The user 70 can then move the selected digital image 330 into the image field 360, which forms personalized photo calendar including a user 70's personal photo. The digital image 330 can be moved by dragging and dropping the selected digital image into the image field 360 in the calendar layout 320. The user can also select and incorporate a digital image 330 into an image field 360 by browsing a directory of file folders and selecting an image file from a folder. Once a digital image 330 is moved to the image field 360, it can be replaced by a second digital image 330 by moving the second digital image 330 into the image field 360. A calendar page can include several image fields 320 for receiving a plurality of digital images 330. The digital images 330 rendered into the calendar layout can for an image collage as shown in FIG. 5c.

A calendar layout 320 can include a plurality of calendar pages. Each of the calendar pages may include one or more image fields 360 for receiving a digital image 330 from the user's personal photo album 310. In addition, a user 70 may have one or more photo albums 310 on his computer 200 or at the website powered by the server 32. In accordance with the present invention, a personalized photo calendar can be generated automatically, by selecting a plurality of digital images 330 from one or more of user 70's photo albums 310. The digital images 330 can be automatically distributed to the different image fields on different calendar pages.

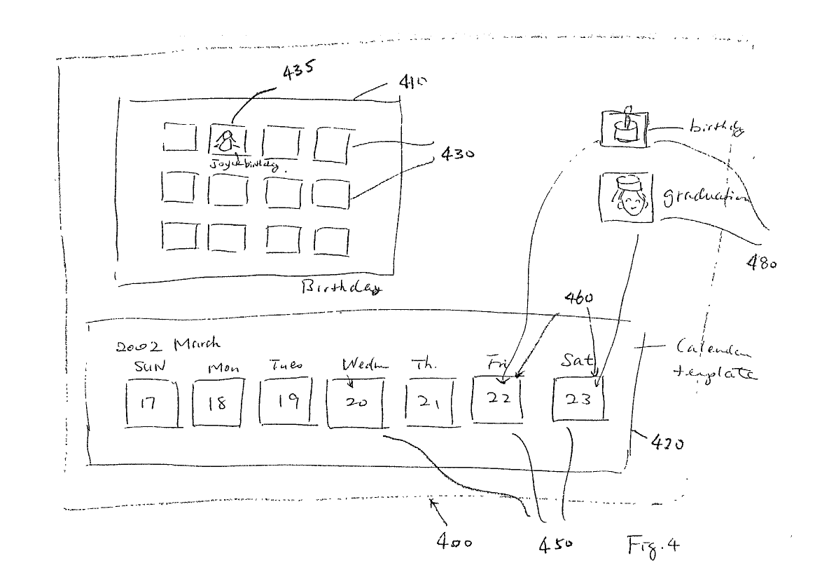

FIG. 4 shows another example of a graphical user interface as viewed on the computer terminal 60 for creating a personalized photo calendar. The graphical user interface 400 includes a photo album 410 and a calendar layout 420. The photo album 410 includes a plurality of digital images 430 provided by the user 70. Some of the digital images 435 include an annotation and/or a title associated with a digital image, for example, “Joyce's Birthday”. The calendar layout 420 includes a plurality of cells 450, each representing a date. In FIG. 4, the date information is illustrated in each of the seven cells 450 representing the seven days in a week. In accordance with the present invention, the image fields 460 in the calendar layout 420 can fully occupy or partially overlap with the cells 450 for the date information.

In accordance with one aspect of the invention, the digital image 435 with an annotation or title can be moved to an image filed 450 that is located in a date cell wherein the date corresponds to the title and the annotation. For example, the digital image 435 with “Joyce's Birthday” can be moved to the date cell for 20^{th}, Wednesday, which corresponds to the birthday for Joyce. The title and annotation information can be carried over to the calendar layout with the selected digital image 430. Personal text information “Joyce's Birthday” can also be added to the date cell in the calendar layout 420 in conjunction with the location of the image field 450. In accordance with the invention, the graphical user interface 400 allows the image field 450 and the personal text information to be moved by the user 70 according to the specific needs of the user 70.

In accordance with the present invention, the digital image 430 can include keywords describing the occasion of each digital image. A digital image 430 can include a plurality of keywords: “Tom, Dad, vacation, golf”. In preparation of creating a personalized photo calendar with a vacation theme, the user 70 can search for the key word “vacation”. A plurality of digital images 430 may be selected as candidates for being incorporated into the calendar layout 420.

Furthermore, the graphical user interface 400 can provide graphic images 480 such as clip art, which can include the graphic pattern for a “birthday cake” and a symbol for “graduation”. These graphic images can also be moved into an image field 450 in association with events such as birthday and graduation.

FIG. 5a shows a perspective view of a hardcopy personalized photo calendar 500. After a hardcopy personalized photo calendar is customarily designed, the user 70 can preview it on the graphic user interface, as shown in FIG. 5. The hardcopy personalized photo calendar 500 comprises a personalized cover page 510 and other personalized photo calendar pages 520. The calendar book is bound together by various binding methods such as coil, wire, ring binding etc. Each calendar page may be printed on both sides (i.e. duplex), or just one side (i.e. simplex printing). FIG. 5b shows a calendar page of the calendar book shown in FIG. 5a. The calendar layout 550 includes an image filed 560, and a plurality of cells 570 for illustrating the days in July 2002.

The personalized cover page 510 includes a personal photo 530, selected from the digital images 330,430 in the photo albums 310,410, and a personal title 540 provided by the user 70. The graphic user interface may provide suggestions for the personal title. The digital images for the cover may be the same as some of the digital images 330,430 that also appear on the other calendar pages. The personalized cover page 510 may present a collection (or a collage) of digital images 330,430 which correspond to the digital images used in the personalized photo calendar page 520 as an overview of the images in the calendar book. The user 70 can preview different personalized photo calendar pages by clicking on a calendar or cover page and flip to the next page. At least one calendar page can include a machine code information (e.g. barcode) for the photo service provider 40,41 to track the orders. The status of each order can be viewed by the user 70 at the photo hosting website.

FIG. 5c shows a planar preview of two hardcopy personalized photo calendars 500 in different formats. The hardcopy personalized photo calendar 500 may include different formats: in a single sheet or the form a book, sizes in 11″×17″, 8.5″×11″, 5″×7″, and a pocket size. The hardcopy personalized photo calendar 500 shown in FIG. 5a can be displayed by hanging off a wall. The hardcopy personalized photo calendar 500 can also be for standing on a desk or shelf surface. The hardcopy personalized photo calendar 500 can also be produced on novel substrate such as magnetic pad (for sticking to a refrigerator), a mug, a plate, or locket for a dated decoration, etc. Each calendar of the same format may be received by a multiple of recipients 100, 105 as specified by user 70. In addition, each recipient 100 or 105 can receive hardcopy personalized photo calendars 500 of different formats ordered by the same user 70.

The hardcopy personalized photo calendar 500 can be printed on a photosensitive silver halide paper using a digital photo printer such as Fuji's Frontier Minilab 390, or on a coated cover paper using an offset digital press such Indigo UltraStream Press, available from Indigo Inc., a Hewlett Packard company.

The user 70 can order other photo products at the time he orders hardcopy personalized photo calendar 500 from the photo service provider on the online photo website. For example, the user 70 may also order photo prints, a CD of his photos, and a greeting card to be shipped to the same recipient 100, 105. These photo products can be consolidated in a single package together with the hardcopy personalized photo calendar 500 at the printing and finishing facility 40,41 before being shipped to the recipient 100,105 or to the user 70.

The preview of the hardcopy personalized photo calendar can be in two-dimensional pages or in perspective views. Details of the user interface for previewing including perspective previewing of a photo products are disclosed in the above referenced and commonly assigned U.S. patent application Ser. No. 09/684,595, filed on Oct. 5, 2000, titled “Previewing a framed image print”, by Haeberli, the disclosure of which is incorporated herein by reference.

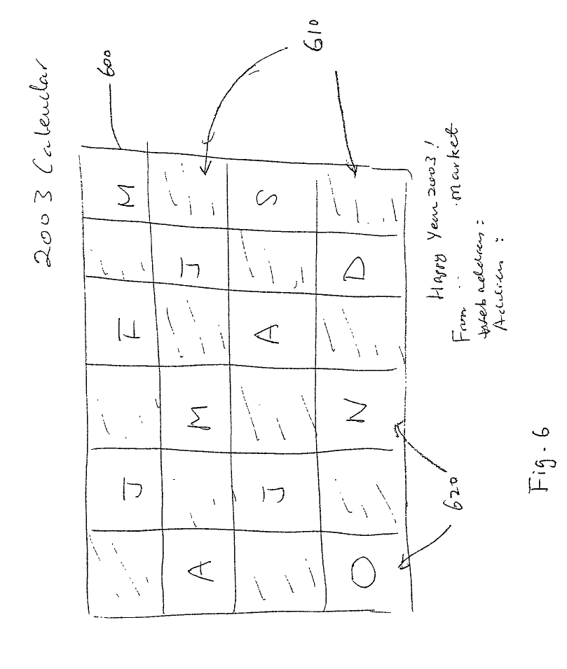

The image field 360 can appear in half of a calendar page as shown FIG. 3. Or alternatively, as shown in the calendar layout 600 in FIG. 6, the image fields 610 can be distributed next to the date cells 620 in a checker-board pattern. The design of the personalized photo calendar, in soft or hardcopy forms, can be stored on the user 70's computer 200 or on the data storage 34 connected to the server 32. The user 70 can retrieve the information to create and order a new hardcopy personal photo calendar 500 when the last one he ordered is about to be out dated. The dates for personal events such as birthday or anniversary for a user or a recipient can also be saved in the user 70's personal account. The photo service provider can send a reminder for photo products such as a birthday cards before the date of the personal events.

The calendar layout can include features that are variable by the user 70. The variable features in the calendar layout can include font size, font color, font style, background color and background pattern in the calendar layout. The background color and pattern can carry a theme such as sports, girls, school, vacation etc. The theme can also include commercial information, as shown in FIG. 6, including business name, product description, business logo, business locations, website address, e-mail and such as phone numbers, etc.

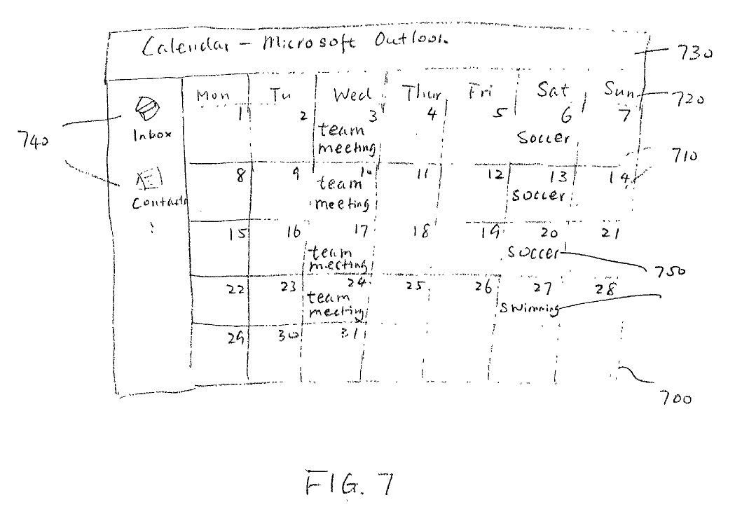

The calendar layout 320, 420 can extract information from an electronic calendar provided a personal account at a web site such as Yahoo!, or an computer application such as Microsoft Outlook, or an organization software on a portable handheld device such as Palm. FIG. 7 shows an electronic calendar 700 that the user 70 can use for scheduling activities in a desktop environment. The electronic calendar 700 can include a plurality of cells 710 for holding date information, text information 720 (e.g. Monday, Tuesday . . . ), header information 730, file folders 740 such as e-mails, address book etc., and event information 750. The event information 750 in the electronic calendar 700 can be exported to an out file, which can in turn be extracted by an application program 213 into the calendar layout 320, 420. The user 70 can selectively edit the activities to be incorporated into the personalized photo calendars.

Various implementations of the systems and techniques described here may be realized in digital electronic circuitry, or in computer hardware, firmware, software, or in combinations thereof. A system or other apparatus that uses one or more of the techniques and methods described here may be implemented as a computer-readable storage medium, configured with a computer program, where the storage medium so configured causes a computer system to operate on input and/or generate output in a specific and predefined manner. Such a computer system may include one or more programmable processors that receive data and instructions from, and transmit data and instructions to, a data storage system, and suitable input and output devices. Each computer program may be implemented in a high-level procedural or object-oriented programming language, or in assembly or machine language if desired; and in any case, the language may be a compiled or interpreted language. Suitable processors include, by way of example, both general and special purpose microprocessors.

A number of embodiments have been described. Nevertheless, it will be understood that various modifications may be made without departing from the spirit and scope of the invention. For example, advantageous results still could be achieved if steps of the disclosed techniques were performed in a different order and/or if components in the disclosed systems were combined in a different manner and/or replaced or supplemented by other components. Accordingly, other embodiments are within the scope of the following claims.

Element Number List

10 system for producing personalized photo calendars

20 online photo system

30 data center

32 server

34 data storage devices

36 computer processor

40 printing and finishing facility

41 printing and finishing facility

42 network server

43 film processor

44 scanner

45 printer

46 finishing equipment

48 shipping station

50 Internet

60 computer terminal

70 user

80 computer network

100 recipient

105 recipient

110 share recipient

200 computer

203 mouse

205 keyboard

206 card reader

207 computer display

208 digital camera

209 memory

210 non-volatile memory

211 operating system

213 application program

217 I/O unit

221 Central Processing Unit (CPU)

223 communication device

225 communications link

230 digital printer

300 graphical user interface

310 photo album

320 calendar layout

330 digital image

350 cell

360 image field

370 image border

400 graphical user interface

410 photo album

420 calendar layout

430 digital image

450 cell

460 image field

480 image border

500 hardcopy personalized photo calendar

510 personalized cover page

520 personalized photo calendar page

530 personal photo

540 personal title

550 calendar layout

560 image filed

570 cells

600 calendar layout

610 image field

620 date cell

700 electronic calendar

710 cells

720 text information

730 header information

740 file folders

750 event information

What is claimed is:

1. A method for producing a personalized photo calendar for a user, comprising:
a) receiving one or more user generated digital images;
b) displaying a calendar layout, the calendar layout including at least one image field for receiving a digital image;
c) selecting a user generated digital image from the received user generated digital images; and
d) rendering the calendar layout with selected user generated image in the image field to form the personalized photo calendar.

2. The method of claim 1, further comprising generating the user generated digital images using an image capture device including a digital camera or a scanner.

3. The method of claim 1, wherein the image field in the calendar layout is surrounded by a pre-designed image border.

4. The method of claim 1, wherein the image field can be moved by the user to a different location in the calendar layout.

5. The method of claim 1, wherein the rendering of the calendar layout includes moving the selected user generated image to the image field.

6. The method of claim 1, wherein the digital image includes an annotation or a title.

7. The method of claim 1, wherein the calendar layout includes personalized text information provided by the user.

8. The method of claim 1, wherein the calendar layout includes features variable by the user.

9. The method of claim 8, wherein the variable features in the calendar layout include one or more of the features: the font size, the font color, the font style, the background color and the background pattern in the calendar layout.

10. The method of claim 1, wherein the calendar layout includes information extracted from an electronic calendar.

11. The method of claim 1, wherein the calendar layout includes one or more calendar pages and a cover page having personalized information from the user.

12. The method of claim 11, wherein the personalized information on the cover page includes an image or text information provided by the user.

13. The method of claim 1, wherein the calendar layout includes cells representing different dates and at least one image field is located inside a cell in the calendar layout.

14. The method of claim 1, wherein the calendar layout includes information about an ethnic calendar, an ethnic event, or a religious event.

15. The method of claim 1, further comprising:
e) inputting a start date, an end date, and a time increment for the personalized photo calendar.

16. The method of claim 1, further comprising:
e) previewing the personalized photo calendar.

17. A method for producing personalized photo calendar, comprising:
a) producing digital images using an image capture device;
b) transferring the digital image data to a computer by a user;
c) receiving data for a calendar layout from a server by the computer, the calendar layout including at least one image field for receiving a digital image;
d) displaying the calendar layout;
e) selecting a digital image from the digital images received by the computer;
f) moving the selected digital image to the image field in the calendar layout, thereby forming a personalized photo calendar; and
g) storing data related to the personalized photo calendar on a data storage connected to the server.

18. The method of claim 17 further comprising:
h) displaying the digital images.

19. The method of claim 18, wherein the displayed digital images are arranged in a photo album.

20. The method of claim 19, wherein the personalized photo calendar is automatically generated from the digital images selected in one or more photo albums.

21. The method of claim 17, wherein each of the digital images is assigned with one or more keywords and the personalized photo calendar is generated based on the keywords.

22. The method of claim 17, wherein the image field can be moved by the user to a different location in the calendar layout.

23. The method of claim 17, further comprising:
h) selecting a different digital image and moving such different digital image to the image field in the calendar layout to replace the originally selected digital image.

24. The method of claim 17, wherein the image field in the calendar layout is surrounded by a pre-designed image border.

25. The method of claim 24, wherein the pre-designed image border is associated with a date or season in the image template.

26. The method of claim 17, wherein the digital image includes an annotation or a title that is selected or input by the user.

27. The method of claim 17, wherein the calendar layout includes personalized text information provided by the user.

28. The method of claim 17, wherein the calendar layout includes features variable by the user.

29. The method of claim 28, wherein the variable features in the calendar layout include one or more of the features: the font size, the font color, the font style, the background color and the background pattern in the calendar layout.

30. The method of claim 17, wherein the calendar layout includes information extracted from an electronic calendar.

31. The method of claim 17, wherein the calendar layout includes a cover page including personalized information from the user.

32. The method of claim 31, wherein the personalized information on the cover page includes received digital image or text information provided by the user.

33. The method of claim 17, wherein the calendar layout includes cells representing different dates and at least one image field is located inside a cell in the calendar layout.

34. The method of claim 17, wherein the calendar layout includes information about an ethnic calendar, ethnic events, or religious events.

35. The method of claim 17, further comprising:
h) inputting a start date, an end date, and a time increment for the personalized photo calendar.

36. The method of claim 17, further comprising:
h) previewing the personalized photo calendar.

37. The method of claim 17, wherein the digital image data are received by the server from the user.

38. The method of claim 37, wherein the digital image data is transferred to the server by uploading the digital image data over a computer network.

39. The method of claim 37, wherein the digital image data is extracted from a memory device that is sent to the photo service provider by the user.

40. The method of claim 17, further comprising:
h) specifying a recipient by a user; and
i) sharing the personalized photo calendar with a recipient specified by the user.

44. A method for producing a hard copy personalized photo calendar, comprising:
a) producing digital images using an image capture device;
b) transferring the digital image data to a computer by a user;
c) receiving data for a calendar layout from a server, such calendar layout including at least one image field for receiving a digital image;
d) displaying the calendar layout;
e) selecting a digital image from the digital images received by the computer;
f) moving the selected digital image to the image field in the calendar layout, thereby forming a personalized photo calendar;
g) storing data related to the personalized photo calendar on a data storage connected to the server;
h) producing a hardcopy personalized photo calendar in accordance with the personalized photo calendar at the website; and
i) shipping the hardcopy personalized photo calendar to recipients specified by a user.

45. The method of claim 44, further comprising:
j) inputting address information for one or more recipients;

46. The method of claim 44, wherein the digital image data was uploaded to the server from the computer.

47. The method of claim 44, wherein the hardcopy personalized photo calendar is in the form of a calendar book having a plurality of calendar pages.

48. The method of claim 44, wherein the calendar layout includes date information, such date information being printed on the same or different calendar pages where the selected digital image is printed.

49. The method of claim 44, wherein the calendar layout includes personalized text information provided by the user.

50. The method of claim 44, wherein the calendar pages include a personalized photo cover page, such personalized photo cover page including at least one digital image received by the computer from the user.

51. The method of claim 50, wherein at least one of the digital images on the personalized photo cover page is also printed on other calendar pages.

52. The method of claim 44, wherein the hardcopy personalized photo calendar is printed on one of the receiver types: plain paper, coated paper, photosensitive paper, transparent material, plastic or metal substrate.

53. The method of claim 44, wherein calendar layout includes a plurality of cells, each of such cells including fields for receiving information and a digital image.

54. The method of claim 44, wherein the hardcopy personalized photo calendars are produced in different formats.

55. The method of claim 53, wherein the different formats for the hardcopy personalized photo calendar include hardcopy calendars for hanging off a surface or standing on a surface.

56. The method of claim 54, wherein the different formats for the hardcopy personalized photo calendar include calendars printed on one side or both sides of a calendar page.

57. The method of claim 54, wherein different formats of hardcopy personalized photo calendars are produced and shipped to a single recipient.

58. The method of claim 54, wherein the hardcopy personalized photo calendars of the same format are produced and shipped to different recipients.

59. The method of claim 44, wherein the hardcopy personalized photo calendar is produced at location remote to the computer.

60. The method of claim 44, wherein the hardcopy personalized photo calendar is printed using a digital electrographic offset printer.

61. The method of claim 44, wherein the hardcopy personalized photo calendar is printed using a digital photographic printer.

62. The method of claim 44, wherein the step of producing a hardcopy personalized photo calendar includes one or more of the finishing steps of cutting, folding, punching, stapling, gluing, and binding.

63. The method of claim 44, wherein the hardcopy personalized photo calendar includes a barcode for tracking the order of the hardcopy personalized photo calendar.

64. The method of claim 44, further comprising
j) previewing the hardcopy personalized photo calendar.

65. The method of claim 63, wherein the previewing includes a perspective view of the hardcopy personalized photo calendar.

66. The method of claim 44, further comprising
j) making payment by the user to the service that produces the calendars for the user.

67. The method of claim 44, further comprising
j) sending a reminder to the user or the recipient for making a hardcopy personalized photo calendar.

68. A system for creating personalized photo calendar for a user in response to digital image data, comprising:
a) an image capture device to produce digital image data for the user;
b) a computer to receive the digital image data;
c) a display device coupled to the computer to display the calendar layout, the calendar layout including at least one image field for receiving a digital image; and
d) an input device in connection with the computer to select a digital image from the received digital images and move the selected digital image to the image field in the calendar layout, thereby forming a personalized photo calendar.

69. A system for creating personalized photo calendars, comprising:
a) a computer to receive user generated digital image data and for selecting at least one of the received digital images;
b) a server to distribute data associated with a calendar layout to the computer, such calendar layout including at least one image field for receiving a digital image;
c) a display device in connection with the computer to display the calendar layout; and
d) an input device in connection with the computer to move the selected digital image to the image field in the calendar layout, thereby forming a personalized photo calendar, such personalized photo calendar being stored on a data storage connected to the server.

70. A system for producing a hardcopy personalized photo calendars for a user, comprising:
a) a computer to receive user generated digital image data and select at least one of the received digital images;
b) a server to distribute data associated with a calendar layout to the computer, the calendar layout including at least one image field for receiving a digital image;
c) a display device in connection with the computer to display the calendar layout;
d) an input device in connection with the computer to move the selected digital image to the image field in the calendar layout and to form a personalized photo calendar; and
e) a facility for producing a hardcopy personalized photo calendar in accordance with the personalized photo calendar, the hardcopy personalized photo calendar being shipped to a recipient specified by the user.
